(19) United States
(12) Patent Application Publication
(10) Pub. No.: US 2007/0104346 A1
(43) Pub. Date: May 10, 2007

(54) Speaker

(75) Inventor: Koutaro Iekura, Yamagata (JP)

Correspondence Address: ARENT FOX PLLC, 1050 CONNECTICUT AVENUE, N.W., SUITE 400, WASHINGTON, DC, 20036, US

(73) Assignee: Pioneer Corporation

(21) Appl. No.: 11/588,415

(22) Filed: Oct. 27, 2006

(30) Foreign Application Priority Data
Oct. 27, 2005 (JP) 2005-313133

(51) Int. Cl. H04R 9/06

(52) U.S. Cl. 381/396

(57) ABSTRACT

A speaker is provided with a magnetic circuit for driving a diaphragm which is disposed at a sound emission side of the diaphragm, a magnetic circuit supporting member, which is formed at a central portion inside the outer frame supporting the diaphragm, for supporting the magnetic circuit at a tip portion thereof protruding in a sound emission direction, and a network element disposed within the magnetic circuit supporting member. Thereby, a damage of the network element can be prevented with a simple configuration of the speaker. In addition, the speaker with such a configuration needs no extra space for mounting the network element, and also no fixing construction for mounting the network element.

### BACKGROUND OF THE INVENTION

1. Field of the Invention

The present invention relates to a structure of a speaker.

The present application claims priority from Japanese Patent Application No. 2005-313133, the disclosure of which is incorporated herein by reference.

2. Description of the Related Art

Typically, various network elements such as choke coils, capacitors, or resistances are connected to a speaker in order to control acoustic signals or electric signals inputted to the speaker. Conventionally, the network elements are housed in a control box which is separately formed from a speaker frame. The network elements are connected via an extension cord to a relay terminal mounted on the speaker frame. For example, for a vehicle-mounted speaker, however, the wiring must be carried out after securing a space of control box to be mounted in a door or a console of the vehicle, that is, the conventional speaker has a disadvantage that a complicated mounting operation of the network elements is requested. Then, in Japanese Patent Application Laid-Open No. 2005-236424, a speaker P1 having a network element N1 directly mounted on a speaker frame F2 is disclosed as shown in FIG. 1.

In the speaker P1 as mentioned above, the network element N1 is fixed on a rear surface of the speaker frame F2, protruding rearward. In other words, it is necessary to separately provide a fixing structure for fixing the network elements at a rear portion of the speaker frame. In the speaker as mentioned above, there may be a danger that the network element is damaged when or after mounting the speaker since it is protruded rearwards. In addition, the speaker as mentioned above has a disadvantage in which an extra space for mounting the network element is needed separately because of protruding rearwards.

### SUMMARY OF THE INVENTION

The present invention is made for solving the above-mentioned problems. Specifically, an object of the present invention is to provide a speaker with a network element, a simple structure of which can prevent the network element from being damaged by an outer force, and another object is to provide a speaker with a network element which requires no extra mounting space and also no special fixing structure for the network element.

According to the present invention, there is provided a speaker having a diaphragm, an outer frame for supporting an outer end of the diaphragm, a voice coil bobbin provided with a voice coil on an outer surface thereof, and a damper for supporting an inner end of the diaphragm and the voice coil bobbin as described in the preamble of claim 1. The speaker comprises a magnetic circuit, which is disposed at a sound emission side of the diaphragm, for driving the diaphragm, a magnetic circuit supporting member for supporting the magnetic circuit at a tip portion thereof protruding in a sound emission direction, the magnetic circuit supporting member being formed at a central portion inside the outer frame supporting the diaphragm, and a network element provided within the magnetic circuit supporting member in order to control acoustic signals inputted to the speaker.

### BRIEF DESCRIPTION OF THE DRAWINGS

These and other objects and advantages of the present invention will become clearly understood from the following description with reference to the accompanying drawings, wherein:

FIG. 1 is a diagram showing a schematic construction of a conventional speaker;

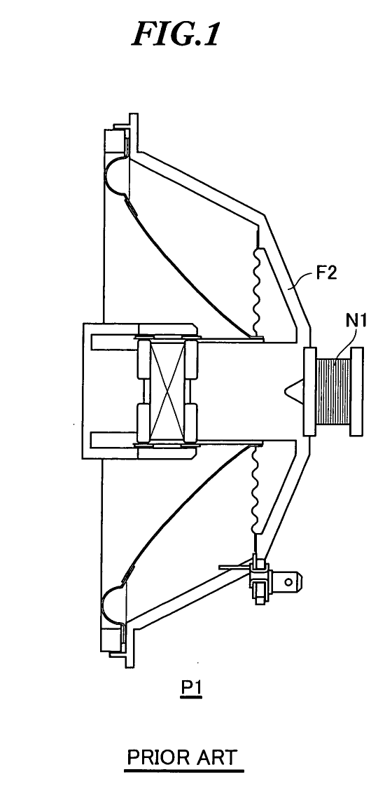

FIG. 2 is a sectional view for explaining a speaker 1 according to a first embodiment of the present invention;

FIG. 3 is a sectional view for explaining a speaker 1b according to a second embodiment of the present invention;

FIG. 4 is a sectional view for explaining a speaker 1c according to a third embodiment of the present invention; and

FIG. 5 is a sectional view for explaining a speaker 1d according to a fourth embodiment of the present invention.

### DETAILED DESCRIPTION OF THE PREFERRED EMBODIMENTS

A speaker according to one embodiment of the present invention comprises a diaphragm, a magnetic circuit disposed at the sound emission side of the diaphragm for driving the diaphragm, a magnetic circuit supporting member located below the magnetic circuit within a speaker frame, and a network element provided inside the magnetic circuit supporting member to control acoustic signals inputted to the speaker. The magnetic circuit supporting member is disposed at an inside central portion of a frame member which supports the diaphragm and forms an entire or a part of the speaker outer frame. Further, the magnetic circuit supporting member penetrates a central portion of the diaphragm from a rear portion of the speaker, and supports the magnetic circuit at a tip thereof protruding into the sound emission side.

In the speaker as mentioned above, it is possible to prevent the network element such as choke coil, capacitor or resistance from breaking with the simple construction of speaker according to the present invention since the network element is provided within the magnetic circuit supporting member. The network element controls acoustic signals (electric signals) inputted, for example, to the voice coil or the like. Further, since there is provided the network element within the magnetic circuit supporting member, there is no need to provide an extra mounting space for mounting the network element. Additionally, there is no need also to separately provide a fixing structure for the network element.

Some embodiments of the speaker of the present invention will be explained hereinafter with reference to the attached drawings.

### First Embodiment

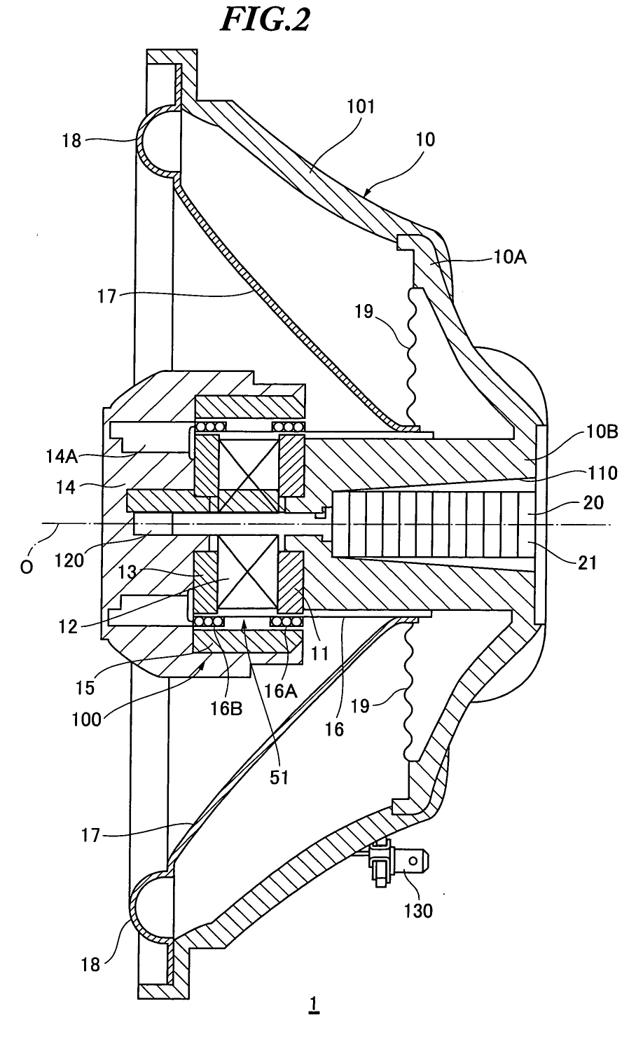

FIG. 2 is a sectional view for explaining a speaker 1 concerned with a first embodiment of the present invention

As shown in FIG. 2, the speaker 1 of the present embodiment includes a frame body 10A, a magnetic circuit supporting member 10B, a first plate 11, a magnet 12, a second plate 13, a supporting frame 14, a yoke 15, a voice coil bobbin 16, a first voice coil 16A, a second voice coil 16B, a diaphragm 17, an edge 18, a damper 19, and a network element 20. The magnetic circuit supporting member 10B corresponds to one embodiment of the magnetic circuit supporting member concerned with the present invention. The network element 20 corresponds to one embodiment of the network element concerned with the present invention. Also, a magnetic circuit 100 comprising, for example, the first plate 11, the magnet 12, the second plate 13, the supporting frame 14, and the yoke 15, corresponds to one embodiment of the magnetic circuit concerned with the present invention. The respective sections will be explained hereinafter in detail.

As shown in FIG. 2, for example, the speaker 1 concerned with the present embodiment schematically comprises the substantially cup-shaped frame body 10A which forms an outer wall portion of the speaker 1 and the substantially cylinder-shaped magnetic circuit supporting member 10B which is integrally formed with the frame body 10A to concentrically extend toward an opening side from a central depth portion thereof. The frame body 10A and the magnetic circuit supporting member 10B corresponds to a frame member 10 which forms an entire of or a part of speaker outer wall and supports a diaphragm 17. In the present embodiment, a side surface 101 of the speaker frame provided with vent holes is formed adjacently to the frame body 10A.

The magnetic circuit supporting member 10B includes a recessed portion 110 therein which has an opening in an opposite direction of the sound emission side, and also the recessed portion 110 extends until around central portion of the magnetic circuit supporting member 10B. Inside the recessed portion 110, there is provided the network element 20.

As shown in FIG. 2, the ring-shaped first plate 11 having a larger outer diameter than that of the magnetic circuit supporting member 10B is concentrically fixed at a tip surface of the magnetic circuit supporting member 10B. Also, the cylindrical magnet 12 having a smaller outer diameter than that of the first plate 11 is concentrically fixed at the sound emission side of the first plate 11. Further, at the sound emission side of the magnet 12 is concentrically fixed the second plate 13 having the same outer diameter as one of the first plate 11. In addition, the cylindrical supporting frame 14 having a larger outer diameter than the respective ones of the first plate 11, the magnet 12 and the second plate 13 is concentrically fixed at the sound emission side of the second plate 13.

The supporting frame 14 is provided with a circular-annular groove 14A to have an opening formed concentrically with the body of supporting frame 14 and extended in the opposite direction of sound emission. The circular-annular groove 14A has an inner diameter smaller and an outer diameter larger than the respective outer diameters of the first and second plates 11, 13. The depth of the groove 14A, i.e., the width of the supporting frame 14 toward a central axis (o) thereof, is set larger than amplitude of the diaphragm 17. In the present embodiment, as shown in FIG. 2, the supporting frame 14 is fixed with a screw-shaped fixing member 120 located along the common central axis (o) of the first plate 11, the magnet 12 and the second plate 13.

The ring-shaped yoke 15 is concentrically fixed on a back surface of the supporting frame 14 as shown in FIG. 2. The yoke 15 has the same inner diameter as the outer diameter of the groove 14A. Magnetic gaps 51 are formed between the inner peripheral surface of yoke 15 and the respective outer peripheral surfaces of the first and second plates 11, 13, respectively. In such a way, the magnetic circuit 100 is formed by the first plate 11, the magnet 12, the second plate 13, the supporting frame 14 and the yoke 15.

The voice coil bobbin 16 is concentrically set in the direction of the central axis (o) between the frame body 10A and the magnetic circuit 100 comprising the first plate 11, the magnet 12 and the second plate 13 so that the voice coil bobbin 16 can be vibrated freely along the direction of the central axis (o). A front end portion of the voice coil bobbin 16 is inserted into the magnetic gap 51 which is formed between the first plate 11, the second plate 13 and the yoke 15.

In the magnetic gap 51, the first voice coil 16A and the second voice coil 16B are wound around the outer peripheral surface of first plate 11 and the outer peripheral surface of second plate 13, respectively. The inner peripheral portion of diaphragm 17 with a cone shape is fixed on an outer peripheral surface of the voice coil bobbin 16 at a rear end thereof, whilst the outer peripheral portion of diaphragm 17 is supported by the outer peripheral portion of front edge of the frame body 10A through the edge 18. The damper 19 is provided between the rear end of the voice coil bobbin 16 to which one end of the diaphragm 17 is attached and the frame body 10A. The voice coil bobbin 16 and the diaphragm 17 are supported by the damper 19 so as to be vibrated freely along the direction of the central axis (o).

As already mentioned above, the network element 20 is fixed within the recessed portion 110 of the magnetic circuit supporting member 10B at the back surface side of the frame 10. The network element 20 is an electronic element for controlling the acoustic signal or electric signal inputted into the speaker, and comprises, for example, a choke coil, a capacitor or a resistance. In the embodiment of FIG. 2, the choke coil 21 is used as the network element 20, a central axis of which is disposed substantially along the central axis (o) of the frame 10 or the magnetic circuit supporting member 10B. In other words, the choke coil 21 as the network element 20 is wound around the central axis substantially parallel to the central axis (o) of the frame 10 or the magnetic circuit supporting member 10B.

In the speaker 1 having the configuration as mentioned above, the acoustic signal (electric signal) is inputted from a terminal portion 130 provided on a side surface of the frame body 10A through the network element 20, so that electric current flows from the network element 20 to the first voice coil 16A and the second voice coil 16B. As a result, the voice coil bobbin 16 vibrates along the direction of the central axis (o) through an operation of a magnetic field formed by the magnet 12, and thus the diaphragm 17 is vibrated to output sound wave (compression wave).

In such a way, according to the speaker of the present invention, the network element 20 is stored within the recessed portion surrounded by the magnetic circuit supporting member 10B which supports the magnetic circuit 100 at a tip portion thereof. The magnetic circuit 100 for driving the diaphragm 17 is located at the sound emission side of the diaphragm 17. The magnetic circuit supporting member 10B forms an entire of or a part of the speaker's outer frame, and is disposed at a central portion of and an inside of the frame 10, the tip portion of which protrudes in the direction of sound emission. As an effect thereof, any damage of the network element 20 can be prevented with s simple construction as mentioned above. Further, since the network element is disposed within the magnetic circuit supporting member 10B, there is no need of providing an extra space for mounting the network element 20. Additionally, any special construction for fixing the network element 20 is not necessary.

More specifically, the magnetic circuit supporting member 10B includes the above-mentioned recessed portion 110 which has an opening in the direction opposite to the sound emission side. Through disposing the network element 20 within the recessed portion 110, the speaker 1 of the present invention can be obtained.

Since the network element 20 can be integrally attached with the main body of speaker in such a way, the efficiency of attaching operation can be remarkably improved when adopting the speaker 1 as a vehicle-mounted speaker.

In addition, since the network element 20 is provided within the magnetic circuit supporting member 10B, the influence of the network element 20 to the magnetic circuit 100 is decreased, thereby preventing any deterioration in performance of the speaker.

Further, according to the speaker 1 as mentioned above, the magnetic circuit 100 is disposed at the sound emission side of the diaphragm 17 with the cone shape, that is, inside a cone thereof, so that the speaker 1 can be formed thinner, which is advantageous when mounting it on the vehicle.

### Second Embodiment

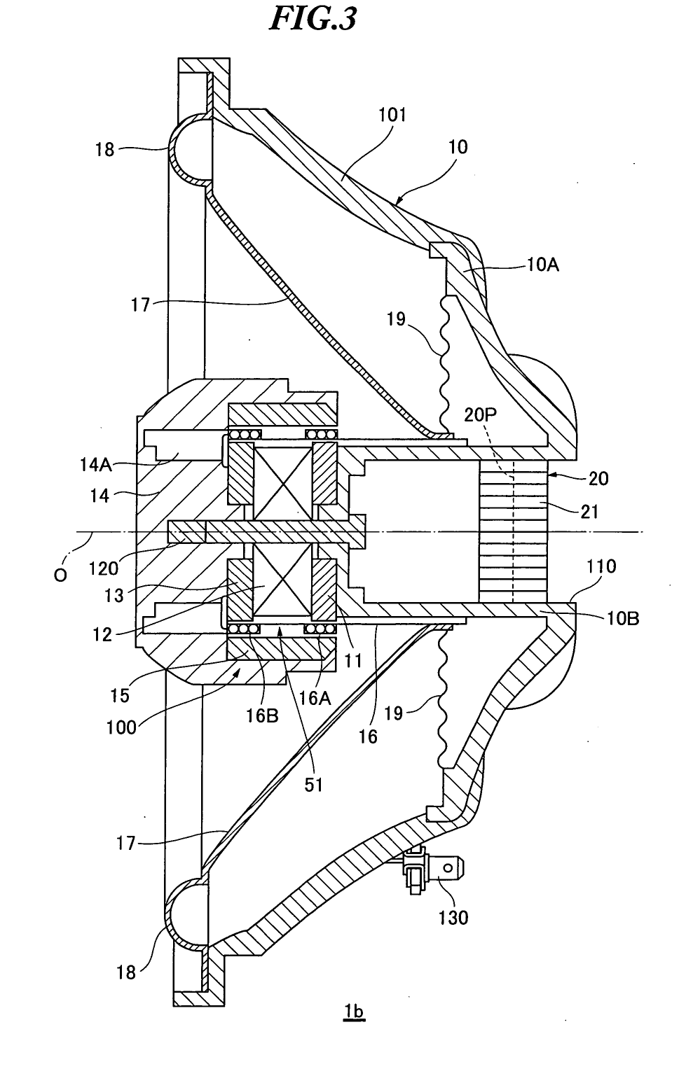

FIG. 3 is a sectional view for explaining a speaker 1b concerned with the second embodiment of the present invention. Whilst the choke coil 21 as the network element 20 of the speaker 1 concerned with the first embodiment is wound around the concentric central axis (o) with a magnetic circuit supporting member 10B and the frame 10 within the magnetic circuit supporting member 10B, the network element 20 of the speaker 1b concerned with the second embodiment are wound around another central axis 20P which is located in the recessed portion 110 formed by the magnetic circuit supporting member 10B. The central axis 20P is substantially orthogonal to the central axis (o) of the frame 10 or the magnetic circuit supporting member 10B. Specifically, the speaker 1b of the present embodiment adopts the choke coil 21 as the network element, which is wound around the central axis 20P orthogonal to the central axis (o). As shown in FIG. 3, the other parts of the speaker 1b are substantially the same as those of the speaker 1, and thus the same reference numerals as those in FIG. 2 are assigned to the same parts.

Since the network element 20 is disposed in the direction orthogonal to the direction of thickness of speaker 1b, the height of magnetic circuit supporting member 10B along the central axis (o) can be reduced more than that of the speaker 1 concerned with the first embodiment. Thereby, the thickness of the speaker 1b can be decreased.

### Third Embodiment

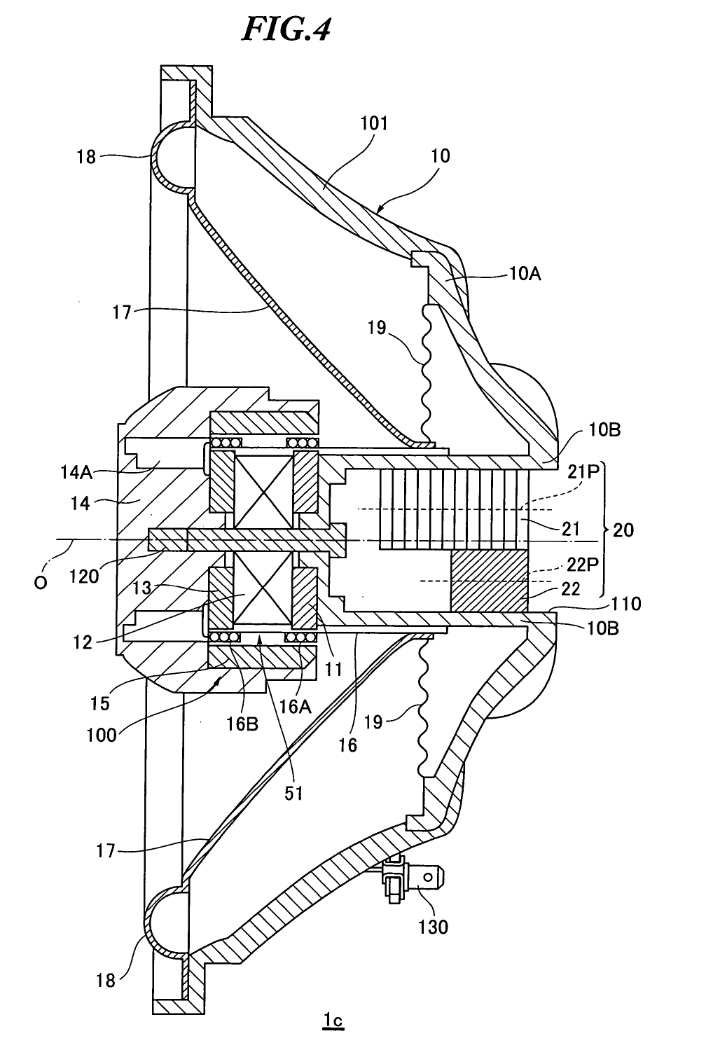

FIG. 4 is a sectional view for explaining a speaker 1c concerned with the third embodiment of the present invention. As shown in FIG. 4, the speaker 1c has a plurality of network elements, i.e., the choke coil 21 and a capacitor 22, within the magnetic circuit supporting member 10B. The choke coil 21 is mounted along the central axis 21P which is substantially parallel to the central axis (o) of the frame 10 or the magnetic circuit supporting member 10B. Further, the capacitor 22 is located adjacently to the choke coil 21, the central axis 22P of which is also substantially parallel to the central axis (o) of the frame 10 or the magnetic circuit supporting member 10B. Here, a longer axis of the capacitor 22 is set to become the central axis 22P. The other parts of the speaker 1c are substantially the same as those of the speaker 1, 1b, then any explanation with regard to the same parts are omitted.

According to the speaker 1c of the third embodiment, a plurality of network elements can be provided therein, which is different from the speaker 1, 1b of the first and second embodiment.

In addition, since the choke coil 21 and the capacitor 22 are separately fixed within the magnetic circuit supporting member 10B, in which the respective central axes of the choke coil 21 and the capacitor 22 are disposed substantially parallel to the central axis (o) of the frame 10 or the magnetic circuit supporting member 10B. As a result, even if an inner diameter of the recessed portion 110 within the magnetic circuit supporting member 10B in the central axis direction is small, a plurality of network elements can be located within the magnetic circuit supporting member 10B.

### Fourth Embodiment

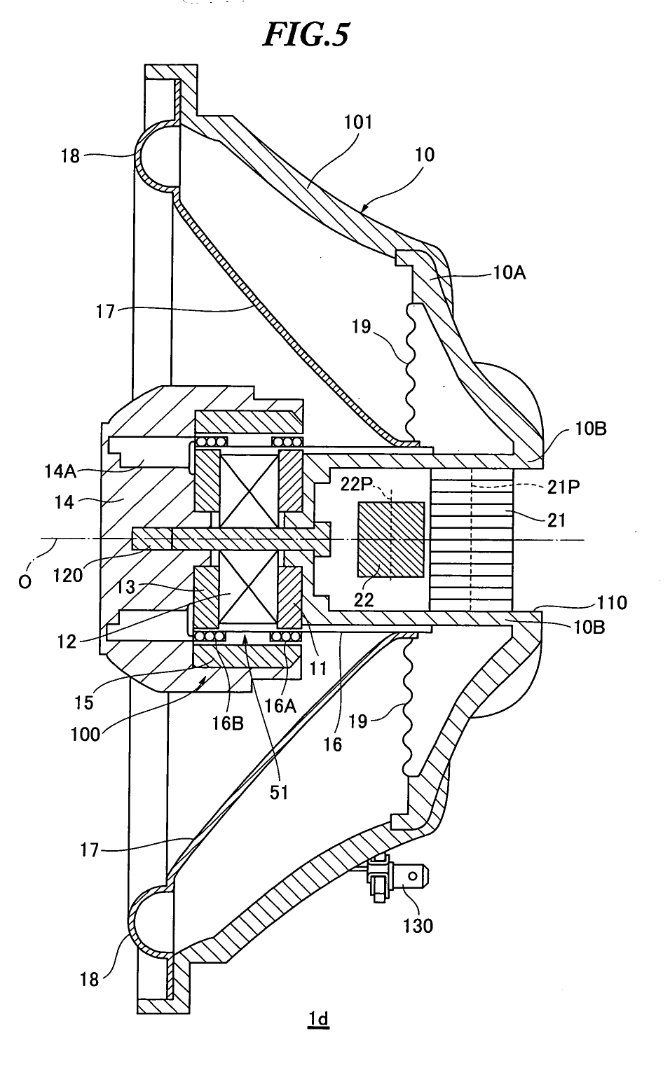

FIG. 5 is a sectional view for explaining a speaker 1d concerned with the fourth embodiment of the present invention. As shown in FIG. 5, the speaker 1d has a plurality of network elements, i.e., the choke coil 21 and the capacitor 22, within the magnetic circuit supporting member 10B. The choke coil 21 is mounted along the central axis 21P which is substantially orthogonal to the central axis (o) of the frame 10 or the magnetic circuit supporting member 10B. Further, the capacitor 22 is located adjacently to the choke coil 21, the central axis 22P of which is also substantially orthogonal to the central axis (o) of the frame 10 or the magnetic circuit supporting member 10B. Additionally, the capacitor 22 is disposed at an inner side of the choke coil 21, i.e., at the side of sound emission. The other parts of the speaker 1d are substantially the same as those of the speaker 1, 1b, 1c, then the explanation with regard to the same parts are omitted.

As mentioned above, the speaker 1d concerned with the present embodiment has the plurality of network elements 20, i.e., the choke coil 21 and the capacitor 22 within the magnet circuit supporting member 10B, in which the choke coil 21 and the capacitor 22 are separately attached adjacently to each other, each central axis of which is substantially orthogonal to the central axis (o) of the frame 10 or the magnetic circuit supporting member 10B. As a result thereof, compared with the third embodiment, the length of the magnetic circuit supporting member 10B along the central axis (o) is further reduced, so that the thickness of the speaker 1d can be decreased.

Moreover, the present invention is not limited to the above mentioned embodiments.

That is, although the choke coil 21 and the capacitor 22 were explained as the network element 20 in above description, the present invention is not limited to such a configuration. For example, the network elements 20 may include a various kind of electronic elements such as resistance, amplifier element, switching element, or transistor, other than the choke coil 21 and the capacitor 22. Through these network elements 20, the acoustic signal (electric signal) inputted into the voice coil can be controlled more accurately.

Further, although the speaker with the cone-shaped diaphragm was explained in the above mentioned embodiments, the present invention is not limited to this configuration. That is, the diaphragm may have a various kind of shapes, such as cone, dome, plane, circle, or ellipse.

Moreover, although the speaker with an electrically conductive type driving system was used for explanation in the above mentioned embodiments, the present invention is not limited to this configuration. A various kind of driving systems, for example, such as electromagnetic type, electrostatic type or piezoelectric type may be adopted. Further, the magnetic circuit may be either one of an inner magnet type or an outer magnet type. In a word, the most important matter for the present invention is that the network element/elements 20 is/are provided within the magnetic circuit supporting member 10B.

In such a way, according to the speaker of the present invention, the network element 20 is provided within the magnetic circuit supporting member 10B which supports the magnetic circuit 100 at a tip portion thereof. The magnetic circuit 100 for driving the diaphragm 17 is located at the sound emission side of the diaphragm 17. The magnetic circuit supporting member 10B forms an entire of or a part of the speaker's outer frame, and is disposed at a central portion of and an inside of the frame 10, the tip portion of which protrudes in the direction of sound emission. As an effect thereof, any damage of the network element 20 can be prevented with a simple construction as mentioned above. Further, since the network element is provided within the magnetic circuit supporting member 10B, there is no need of providing an extra space for attaching the network element 20. Additionally, any special construction for fixing the network element 20 is not necessary in the present invention.

While the present invention has been described in connection with the preferred specific embodiments thereof, it will be understood that the description is intended to illustrate and does not limit the scope of the present invention, which is defined just by the following claims.

What is claimed is:

1. A speaker having a diaphragm, an outer frame for supporting an outer end of the diaphragm, a voice coil bobbin provided with a voice coil on an outer surface thereof, and a damper for supporting an inner end of the diaphragm and the voice coil bobbin, comprising:
a magnetic circuit for driving the diaphragm, said magnetic circuit being disposed at a sound emission side of the diaphragm;
a magnetic circuit supporting member for supporting said magnetic circuit at a tip portion thereof protruding in a sound emission direction, said magnetic circuit supporting member being formed at a central portion inside the outer frame supporting the diaphragm; and
a network element provided within said magnetic circuit supporting member in order to control acoustic signals inputted to the speaker.

2. The speaker according to claim 1, wherein
said magnetic circuit supporting member includes a recessed portion having an opening in an opposite direction of the sound emission direction, and
said network element is disposed inside said recessed portion of said magnetic circuit supporting member.

3. The speaker according to claim 1, wherein
said network element is either one of choke coil, capacitor, or resistance.

4. The speaker according to claim 3, wherein
a central axis of said network element is substantially parallel to a central axis of said magnetic circuit supporting member.

5. The speaker according to claim 3, wherein
a central axis of said network element is substantially orthogonal to a central axis of said magnetic circuit supporting member.
